(19) United States
(12) Patent Application Publication
(10) Pub. No.: US 2026/0046988 A1
(43) Pub. Date: Feb. 12, 2026

(54) OPTICAL STRUCTURE FOR ADJUSTING LIGHT-EMITTING ANGLE THROUGH CIRCUIT AND IMPLEMENTATION METHOD THEREOF

(71) Applicant: Hengdian Group Tospo Lighting Co., Ltd., Jinhua (CN)

(72) Inventors: Lifeng Liao, Jinhua (CN); Jiangen Wei, Jinhua (CN); Meiling Jin, Jinhua (CN); Banghong Leng, Jinhua (CN); Kan Li, Jinhua (CN); Liang Chen, Jinhua (CN)

(21) Appl. No.: 19/295,763

(22) Filed: Aug. 11, 2025

(30) Foreign Application Priority Data
Aug. 12, 2024 (CN) 202411098349.3

(51) Int. Cl. H05B 45/10; F21V 5/00; F21Y 103/33; F21Y 115/10; H05B 45/325

(52) U.S. Cl. CPC H05B 45/10; F21V 5/00; H05B 45/325; F21Y 2103/33; F21Y 2115/10

(57) ABSTRACT

Disclosed is an optical structure, including a light source plate and a lens corresponding to the light source plate, where the light source plate is provided with outer-ring light sources, and inner-ring light sources are provided on an inner side of the outer-ring light sources; the lens includes a first lens portion provided opposite to the outer-ring light sources and a second lens portion provided opposite to the inner-ring light sources, and light-emitting angles of the first lens portion and the second lens portion are different; the optical structure further includes a dimming control circuit connected to the light source plate. A current ratio between the outer-ring light source and the inner-ring light source is adjusted through the dimming control circuit to adjust the light-emitting angle.

### CROSS-REFERENCE TO RELATED APPLICATION

This Application claims priority to and the benefit of Chinese patent application No. 202411098349.3, filed Aug. 12, 2024, the entirety disclosure of which is herein incorporated by reference.

### TECHNICAL FIELD

The present disclosure pertains to the technical field of lighting, and particularly relates to an optical structure for adjusting a light-emitting angle through a circuit and an implementation method thereof

### BACKGROUND

With the development of the lighting market, people's demand for lamps is increasing, and lamps with fixed light-emitting angle can no longer meet people's daily lighting needs.

Currently, the light-emitting angle adjustment of lamps on the market is mainly realized in the following ways.

1. The focal length of the lens is adjusted by changing the distance between the lens and the light source, thereby adjusting the angle. In this way, the optical efficiency will change after the focal length is adjusted, resulting in the loss of luminous flux.

2. The light path is changed by adjusting the relative position of two layers of lenses, thereby adjusting the angle. In this way, two layers of optical structures need to be passed through, and the loss of luminous flux is large.

3. The relative position of the lens and the light source is changed by moving the lens, thereby adjusting the angle. In this way, the lens needs to be disassembled, which is more troublesome in operation and will affect the waterproof effect.

### SUMMARY

An object of the present disclosure is to provide an optical structure for adjusting a light-emitting angle of lamp through a circuit to solve the problems set forth in the above background. The optical structure provided by the present disclosure has only one layer of lens and a small luminous flux loss.

Another object of the present disclosure is to provide a method for adjusting a light-emitting angle of a lamp.

To achieve the above-mentioned objects, the present disclosure provides the following technical solutions. An optical structure of a lamp includes a light source plate a dimming control circuit connected to the light source plate, and a lens corresponding to the light source plate, the light source plate is provided with a plurality of outer-ring light sources forming an outer ring, and a plurality of inner-ring light sources forming an inner ring are provided on an inner side of the outer-ring light sources; the lens comprises a first lens portion provided opposite to the outer-ring light sources and a second lens portion provided opposite to the inner-ring light sources, and the first lens portion has a light-emitting angle that is different from a light-emitting angle of the second lens portion; the dimming control circuit is configured to adjust a current ratio between the outer-ring light sources and the inner-ring light sources to regulate a light-emitting angle of the lamp.

Further, to convert an inputted dimming signal into a pulse width modulation (PWM) signal with a duty cycle of 0% to 100% and output a pulse width modulation channel A (PWMA) signal and a pulse width modulation channel B (PWMB) signal that are complementary, the dimming control circuit includes a dimming drive circuit, and the dimming drive circuit comprises a driving chip U1 and a connection terminal S2; the driving chip U1 has a first pin, a second pin, a third pin, a fourth pin, a fifth pin, a sixth pin, a seventh pin, and an eighth pin, the connection terminal S2 has a first pin, a second pin, a third pin, and a fourth pin; the third pin of the driving chip U1 is connected to an anode of a diode DS5, a terminal of a capacitor CS1, a terminal of a capacitor CE1, a cathode of a diode DS4, and the third pin of the connection terminal S2; a cathode of the diode DS5 is connected to a +12 V power supply; the fourth pin of the driving chip U1 is connected to the +12 V power supply and a terminal of a capacitor C3; the eighth pin of the driving chip U1 is connected to a terminal of a capacitor CS2; the fourth pin of the connection terminal S2 is connected to a terminal of a resistor RS1; the second pin of the connection terminal S2 is connected to a terminal of a resistor RS2; the first pin of the connection terminal S2 is connected to a terminal of a resistor RS3; the fifth pin of the driving chip U1 is connected to another terminal of each of the capacitor CS1, the capacitor CE1, the capacitor CS2, the capacitor C3, the resistor RS1, the resistor RS2, and the resistor RS3 and an anode of the diode DS4; the sixth pin of the driving chip U1 is connected to a terminal of a resistor RS6, and another terminal of the resistor RS6 is a pulse width modulation channel A (PWMA) signal output terminal; and the seventh pin of the driving chip U1 is connected to a terminal of a resistor RS5, and another terminal of the resistor RS5 is a pulse width modulation channel B (PWMB) signal output terminal.

Further, to realize circuit isolation, the dimming control circuit further includes an isolation circuit, and the isolation circuit includes an optocoupler U2 and an optocoupler U3, where a first pin of the optocoupler U2 is connected to the PWMA signal output terminal, and a first pin of the optocoupler U3 is connected to the PWMB signal output terminal; a second pin of the optocoupler U2 and a second pin of the optocoupler U3 are connected to the fifth pin of the driving chip U1, a third pin of the optocoupler U2 and a third pin of the optocoupler U3 are connected to a power supply V−, and a fourth pin of the optocoupler U2 and a fourth pin of the optocoupler U3 are connected to a power supply V+.

Further, to realize the current control of outer-ring low-color-temperature LEDs AW, inner-ring low-color-temperature LEDs BW, inner-ring high-color-temperature LEDs BC, and outer-ring high-color-temperature LEDs AC, the dimming control circuit further includes a switching circuit, and the switching circuit includes a metal oxide semiconductor (MOS) transistor QS1 and a MOS transistor QS2, where a drain of the MOS transistor QS1 is connected to cathodes of the outer-ring light sources, and a gate of the MOS transistor QS1 is connected to a Zener diode ZD4, a resistor RS7, and the fourth pin of the optocoupler U2; a drain of the MOS transistor QS2 is connected to cathodes of the inner-ring light sources, and a gate of the MOS transistor QS2 is connected to a Zener diode ZD3, a resistor RS8, and the fourth pin of the optocoupler U3; and a source of the MOS transistor QS1, a source of the MOS transistor QS2, and the other terminal of each of the Zener diode ZD3 and the resistor RS8, the Zener diode ZD4, and the resistor RS7 are connected to the power supply V−.

Further, to protect the MOS transistors, a resistor R1 and a resistor R4 are connected in series between the gate of the MOS transistor QS1 and the power supply V+, and a resistor R2 and a resistor R3 are connected in series between the gate of the MOS transistor QS2 and the power supply V+. The resistors R1-R4 are voltage-dropping and current-limiting resistors.

Further, in the present disclosure, the first lens portion and the second lens portion are superimposed.

Further, in the present disclosure, the second lens portion is provided on an inner-ring side of the first lens portion.

Further, to realize the color temperature adjustment, the dimming control circuit further includes a color temperature adjusting dual in-line package (DIP) switch S1, a MOS transistor QS3, and a MOS transistor QS4; the outer-ring light sources comprise a plurality of outer-ring light emitting diodes (LEDs) AW with lower color temperature and a plurality of outer-ring LEDs AC with higher color temperature, and the inner-ring light sources comprise a plurality of inner-ring LEDs BW with lower color temperature and a plurality of inner-ring LEDs BC with higher color temperature; the color temperature adjusting DIP switch S1 has a first pin, a second pin, a third pin, a fourth pin, a fifth pin, a sixth pin, a seventh pin, and an eighth pin; the fifth pin of the color temperature adjusting DIP switch S1 is connected to the sixth pin of the color temperature adjusting DIP switch S1 to serve as an adjustment pin, and the adjustment pin is connected to the power supply V+; the seventh pin of the color temperature adjusting DIP switch S1 is connected to the eighth pin of the color temperature adjusting DIP switch S1 to serve as a higher-color-temperature mode pin, and the higher-color-temperature mode pin is further connected to the third pin of the color temperature adjusting DIP switch S1; the first pin of the color temperature adjusting DIP switch S1 is connected to the second pin of the color temperature adjusting DIP switch S1 to serve as a lower-color-temperature mode pin, and the lower-color-temperature mode pin is further connected to the fourth pin of the color temperature adjusting DIP switch S1, where anodes of the outer-ring LEDs AW and the inner-ring LEDs BW are connected to the lower-color-temperature mode pin; cathodes of the outer-ring LEDs AW are connected to the drain of the MOS transistor QS1, and cathodes of the inner-ring LEDs BW are connected to the drain of the MOS transistor QS2; anodes of the outer-ring LEDs AC and the inner-ring LEDs BC are connected to the higher-color-temperature mode pin; cathodes of the outer-ring LEDs AC are connected to a drain of the MOS transistor QS4, and cathodes of the inner-ring LEDs BC are connected to a drain of the MOS transistor QS3; a gate of the MOS transistor QS3 is connected to a terminal of a Zener diode ZD5, a terminal of a resistor RS9, and the fourth pin of the optocoupler U3; a gate of the MOS transistor QS4 is connected to a terminal of a Zener diode ZD6, a terminal of a resistor RS10, and the fourth pin of the optocoupler U2; and a source of the MOS transistor QS3, a source of the MOS transistor QS4, and another terminal of each of the Zener diode ZD5, the resistor RS9, the Zener diode ZD3, and the resistor RS8 are connected to the power supply V−.

Further, in the present disclosure, a method for adjusting a light-emitting angle of a lamp is provided, including the steps of: providing the optical structure; and adjusting the current ratio between the outer-ring light sources and the inner-ring light sources via the dimming control circuit to regulate the light-emitting angle of the lamp.

Further, the dimming control includes a dimming drive circuit, the dimming drive circuit includes a driving chip U1, a connection terminal S2, and an isolation circuit, the isolation circuit includes an optocoupler U2 and an optocoupler U3, the outer-ring light sources include a plurality of outer-ring light emitting diodes (LEDs) AW with lower color temperature and a plurality of outer-ring LEDs AC with higher color temperature, and the inner-ring light sources include a plurality of inner-ring LEDs BW with lower color temperature and a plurality of inner-ring LEDs BC with higher color temperature.
the method further includes: connecting the connection terminal S2 to a dimmer, an adjustable potentiometer, or a pulse width modulation (PWM) signal source; converting, by the driving chip U1, an inputted dimming signal into a PWM signal with a duty cycle of 0% to 100%, and outputting a pulse width modulation channel A (PWMA) signal and a pulse width modulation channel B (PWMB) signal that are complementary; connecting a PWMA signal output terminal to gates of a metal oxide semiconductor (MOS) transistor QS1 and a MOS transistor QS4 after isolation via the optocoupler U2; connecting a PWMB signal output terminal to gates of a MOS transistor QS2 and a MOS transistor QS3 after isolation via the optocoupler U3; and controlling switch duty cycles of the MOS transistor QS1, the MOS transistor QS2, the MOS transistor QS3, and the MOS transistor QS4 to regulate currents of the outer-ring LEDs AW, the inner-ring LED BW, the inner-ring LED BC, and the outer-ring LEDs AC, thereby adjusting brightness of corresponding LEDs and consequently adjusting the light-emitting angle of the lamp under effect of the lens.

Compared with the prior art, the beneficial effects of the present disclosure are as follows.

1. The lens of the present disclosure includes the first lens portion and the second lens portion having different light-emitting angles, and the outer-ring light sources corresponding to the first lens portion and the inner-ring light sources corresponding to the second lens portion are provided. A current ratio between the outer-ring light source and the inner-ring light source is adjusted through the dimming control circuit to adjust the light-emitting angle.

2. In the present disclosure, the loss of optical efficiency caused by the traditional way of adjusting the focal length of the lens is avoided, and only one layer of lens structure is provided, thereby reducing the loss of luminous flux. There is no need to disassemble the lens, which makes the operation more convenient and avoids potential water leakage risks.

3. In the present disclosure, a color temperature adjusting DIP switch is further provided, which can not only adjust the light-emitting angle, but also adjust the color temperature, thereby increasing the diversity of the lamp.

4. In the lens of the present disclosure, the first lens portion and the second lens portion may be superimposed or may be separately provided, thereby increasing the

### BRIEF DESCRIPTION OF THE DRAWINGS

FIG. 1 is a schematic structural diagram of a lens and a light source plate of the present disclosure;

FIG. 2 is a schematic diagram of a partial cross-sectional structure of a lens of the present disclosure;

FIG. 3 is a circuit diagram of a dimming drive circuit of the present disclosure;

FIG. 4 is a circuit diagram showing the connection of an isolation circuit, a switching circuit, and a light source circuit of the present disclosure;

FIG. 5 is a schematic diagram of a partial cross-sectional structure of a lens in embodiment 2 of the present disclosure; and

FIG. 6 is a circuit diagram showing the connection of a DIP switch, an isolation circuit, a switching circuit, and a light source circuit in embodiment 3 of the present disclosure.

In the drawings: 1—lens; 2—light source plate; 21—outer-ring light source; 22—inner-ring light source; 3—first lens portion; and 4—second lens portion.

### DETAILED DESCRIPTION

The technical solutions in the embodiments of the present disclosure will be clearly and completely described below in conjunction with the accompanying drawings in the embodiments of the present disclosure. Obviously, the described embodiments are only some embodiments of the present disclosure, not all embodiments. Based on the embodiments of the present disclosure, all other embodiments obtained by a person skilled in the art without inventive effort fall within the scope of the present disclosure.

### EMBODIMENT 1

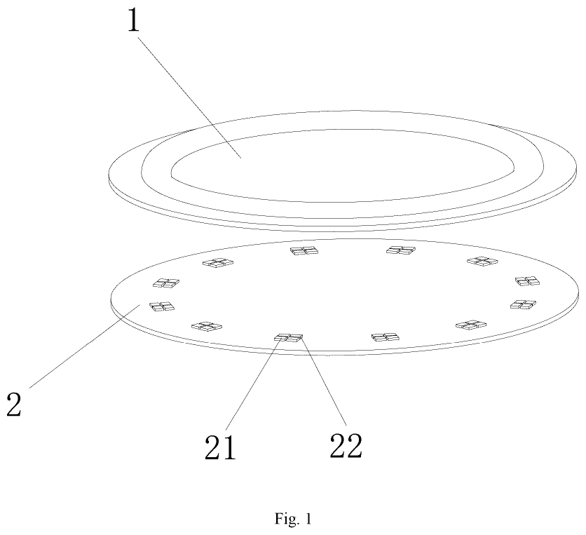

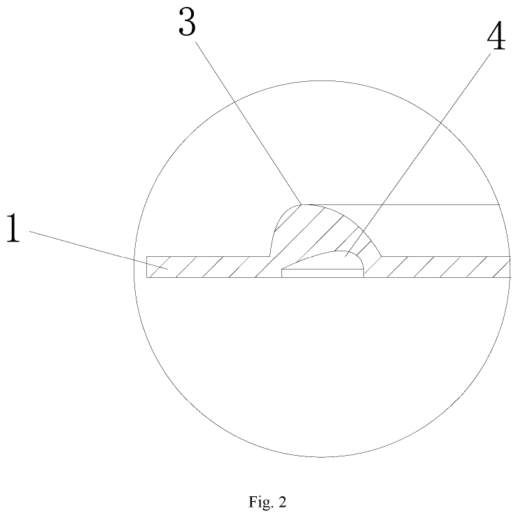

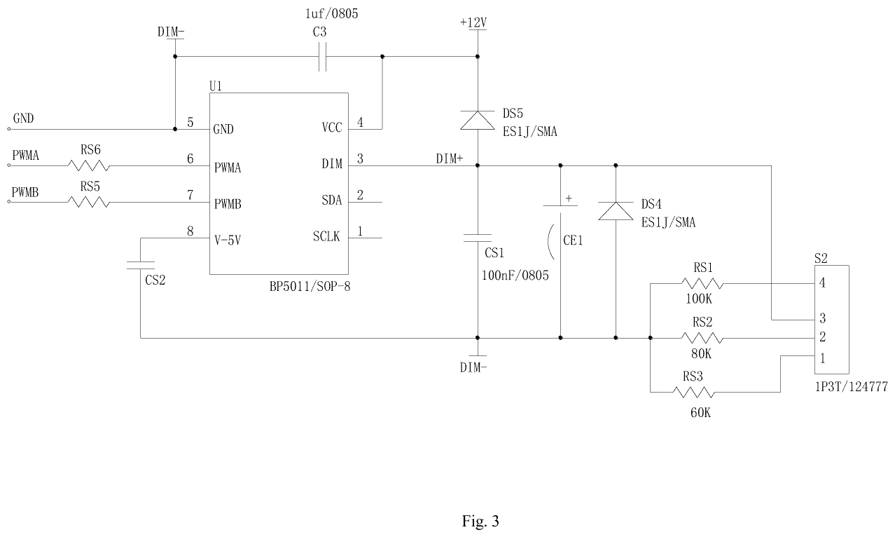

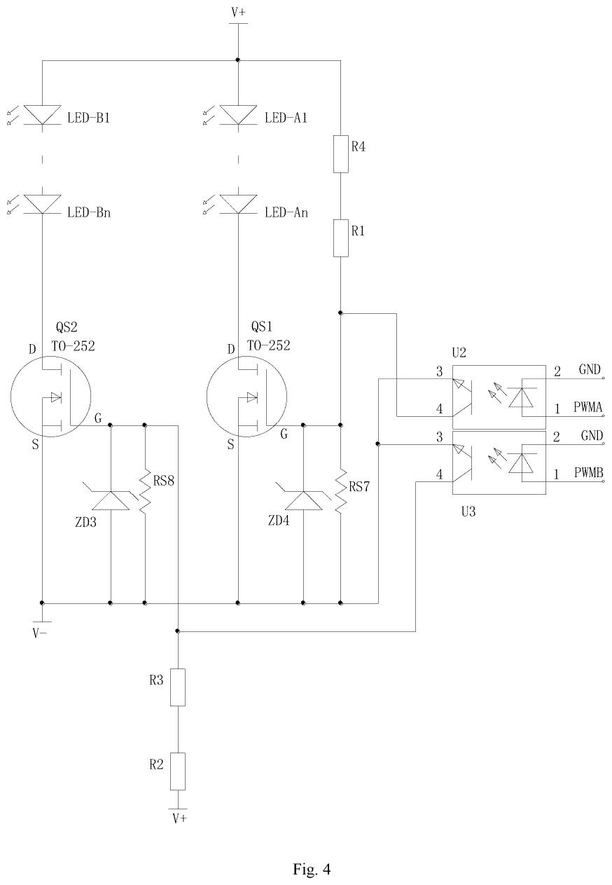

Referring to FIGS. 1-4, the present disclosure provides the following technical solution. An optical structure for adjusting a light-emitting angle of a lamp through a circuit is provided, including a light source plate 2 and a lens 1 corresponding to the light source plate 2. The top surface of the light source plate 2 is provided with a plurality of outer-ring light sources 21 arranged in an annular configuration to form an outer ring and a plurality of inner-ring light sources 22 arranged in an annular configuration to form an inner ring. The inner-ring light sources 22 are provided on an inner side of the outer-ring light sources 21. The lens 1 includes a annular first lens portion 3 provided opposite to the outer-ring light sources 21 and a annular second lens portion 4 provided opposite to the inner-ring light sources 22, and the first lens portion 3 has a light-emitting angle that is different from a light-emitting angle of the second lens portion 4. The first lens portion 3 and the second lens portion 4 are superimposed. That is, as shown in FIG. 2, the planar projection of the first lens portion 3 at least partially overlaps with the planar projection of the second lens portion 4, for example when projected onto the top surface of the light source plate 2 where light sources are provided. Preferably, the planar projection of the first lens portion 3 completely covers the planar projection of the second lens portion 4.

The optical structure further includes a dimming control circuit connected to the light source plate 2. In this embodiment, when the outer-ring light sources 21 are illuminated alone, the light-emitting angle of the entire lamp is 65°, when the inner-ring light sources 22 are illuminated alone, the light-emitting angle of the entire lamp is 105°, and when the outer-ring light sources 21 and the inner-ring light sources 22 are illuminated simultaneously, the light-emitting angle of the entire lamp is 85°.

According to the above-mentioned technical solution, the lens 1 of the present disclosure includes the first lens portion 3 and the second lens portion 4 having different light-emitting angles, and the outer-ring light sources 21 corresponding to the first lens portion 3 and the inner-ring light sources 22 corresponding to the second lens portion 4 are provided. A current ratio between the outer-ring light source 21 and the inner-ring light source 22 is adjusted through the dimming control circuit to adjust the light-emitting angle. In the present disclosure, the loss of optical efficiency caused by the traditional way of adjusting the focal length of the lens is avoided, and only one layer of lens structure is provided, thereby reducing the loss of luminous flux. There is no need to disassemble the lens, which makes the operation more convenient and avoids potential water leakage risks.

Specifically, the dimming control circuit includes a dimming drive circuit, and the dimming drive circuit includes a driving chip U1. A pin 3 of the driving chip U1 is connected to an anode of a diode DS5, a terminal of a capacitor CS1, a terminal of a capacitor CE1, a cathode of a diode DS4, and a pin 3 of a connection terminal S2. A cathode of the diode DS5 is connected to a +12 V power supply. A pin 4 of the driving chip U1 is connected to the +12 V power supply and a terminal of a capacitor C3, and a pin 8 of the driving chip U1 is connected to a terminal of a capacitor CS2. A pin 4 of the connection terminal S2 is connected to a terminal of a resistor RS1, a pin 2 of the connection terminal S2 is connected to a terminal of a resistor RS2, and a pin 1 of the connection terminal S2 is connected to a terminal of a resistor RS3. A pin 5 of the driving chip U1 is connected to the other terminal of each of the capacitor CS1, the capacitor CE1, the capacitor CS2, the capacitor C3, the resistor RS1, the resistor RS2, and the resistor RS3 and an anode of the diode DS4. A pin 6 of the driving chip U1 is connected to a terminal of a resistor RS6, and the other terminal of the resistor RS6 is a PWMA signal output terminal. A pin 7 of the driving chip U1 is connected to a terminal of a resistor RS5, and the other terminal of the resistor RS5 is a PWMB signal output terminal.

According to the above-mentioned technical solution, an inputted dimming signal is converted into a PWM signal with a duty cycle of 0% to 100%, and a PWMA signal and a PWMB signal that are complementary are outputted.

Specifically, the dimming control circuit further includes a switching circuit, and the switching circuit includes a MOS transistor QS1 and a MOS transistor QS2. A drain of the MOS transistor QS1 is connected to cathodes of outer-ring light sources LED-A, and a gate of the MOS transistor QS1 is connected to a Zener diode ZD4, a resistor RS7, and the pin 4 of the optocoupler U2. A drain of the MOS transistor QS2 is connected to cathodes of inner-ring light sources LED-B, and a gate of the MOS transistor QS2 is connected to a Zener diode ZD3, a resistor RS8, and the pin 4 of the optocoupler U3. A source of the MOS transistor QS1, a source of the MOS transistor QS2, and the other terminal of each of the Zener diode ZD3 and the resistor RS8/the other terminal of each of the Zener diode ZD4 and the resistor RS7 are connected to the power supply V−.

According to the above-mentioned technical solution, the current control of outer-ring low-color-temperature LEDs AW, inner-ring low-color-temperature LEDs BWs, inner-ring high-color-temperature LEDs BC, and outer-ring high-color-temperature LEDs AC is realized.

Specifically, a resistor R1 and a resistor R4 are connected in series between the gate of the MOS transistor QS1 and the power supply V+, and a resistor R2 and a resistor R3 are connected in series between the gate of the MOS transistor QS2 and the power supply V+.

According to the above-mentioned technical solution, the resistors R1, R2, R3, and R4 are used as voltage-dropping and current-limiting resistors to protect the MOS transistors.

### EMBODIMENT 2

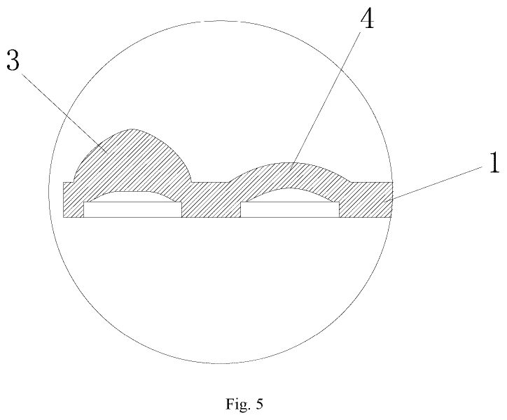

Referring to FIG. 5, this embodiment is different from embodiment 1 in that, specifically, the second lens portion 4 is provided on an inner-ring side of the first lens portion 3.

According to the above-mentioned technical solution, in this embodiment, when the outer-ring light sources 21 are illuminated alone, the light-emitting angle of the entire lamp is 60°, when the inner-ring light sources 22 are illuminated alone, the light-emitting angle of the entire lamp is 120°, and when the outer-ring light sources 21 and the inner-ring light sources 22 are illuminated simultaneously, the light-emitting angle of the entire lamp is 90°.

### EMBODIMENT 3

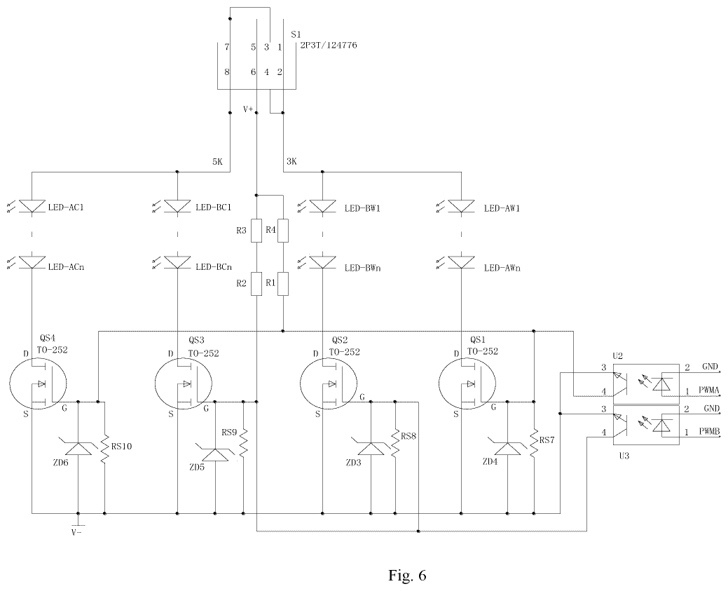

Referring to FIG. 6, this embodiment is different from embodiment 1 in that, specifically, the dimming control circuit further includes a color temperature adjusting DIP switch S1, a MOS transistor QS3, and a MOS transistor QS4, the outer-ring light sources LED-A include outer-ring low-color-temperature LEDs AW and outer-ring high-color-temperature LEDs AC, and the inner-ring light sources LED-B include inner-ring low-color-temperature LEDs BW and inner-ring high-color-temperature LEDs BC. A pin 5 of the color temperature adjusting DIP switch S1 is connected to a pin 6 of the color temperature adjusting DIP switch S1 to serve as an adjustment pin, and the adjustment pin is connected to the power supply V+. A pin 7 of the color temperature adjusting DIP switch S1 is connected to a pin 8 of the color temperature adjusting DIP switch S1 to serve as a high-color-temperature mode pin, and the high-color-temperature mode pin is further connected to a pin 3 of the color temperature adjusting DIP switch S1. A pin 1 of the color temperature adjusting DIP switch S1 is connected to a pin 2 of the color temperature adjusting DIP switch S1 to serve as a low-color-temperature mode pin, and the low-color-temperature mode pin is further connected to a pin 4 of the color temperature adjusting DIP switch S1. Anodes of the outer-ring low-color-temperature LEDs-AWs and the inner-ring low-color-temperature LEDs BW are connected to the low-color-temperature mode pin, cathodes of the outer-ring low-color-temperature LEDs AW are connected to the drain of the MOS transistor QS1, and cathodes of the inner-ring low-color-temperature LEDs BW are connected to the drain of the MOS transistor QS2. Anodes of the outer-ring high-color-temperature LEDs AC and the inner-ring high-color-temperature LEDs BC are connected to the high-color-temperature mode pin, cathodes of the outer-ring high-color-temperature LEDs AC are connected to a drain of the MOS transistor QS4, and cathodes of the inner-ring high-color-temperature LEDs BC are connected to a drain of the MOS transistor QS3. A gate of the MOS transistor QS3 is connected to a terminal of a Zener diode ZD5, a terminal of a resistor RS9, and the pin 4 of the optocoupler U3, and a gate of the MOS transistor QS4 is connected to a terminal of a Zener diode ZD6, a terminal of a resistor RS10, and the pin 4 of the optocoupler U2. A source of the MOS transistor QS3, a source of the MOS transistor QS4, and the other terminal of each of the Zener diode ZD5, the resistor RS9, the Zener diode ZD3, and the resistor RS8 are connected to the power supply V−.

According to the above-mentioned technical solution, not only the light-emitting angle may be adjusted, but also the color temperature may be adjusted.

### EMBODIMENT 4

This embodiment is different from embodiment 1 in that, specifically, the dimming control circuit further includes an isolation circuit, the isolation circuit includes an optocoupler U2 and an optocoupler U3, and the optocoupler U2 and the optocoupler U3 both utilize the model EL817C. A pin 1 of the optocoupler U2 is connected to the PWMA signal output terminal, and a pin 1 of the optocoupler U3 is connected to the PWMB signal output terminal. A pin 2 of the optocoupler U2 and a pin 2 of the optocoupler U3 are connected to the pin 5 of the driving chip U1, a pin 3 of the optocoupler U2 and a pin 3 of the optocoupler U3 are connected to a power supply V−, and a pin 4 of the optocoupler U2 and a pin 4 of the optocoupler U3 are connected to a power supply V+.

### According to the Above-mentioned Technical Solution, Line Isolation Is Realized.

### EMBODIMENT 5

Further, a method for adjusting a light-emitting angle of a lamp is provided in the present disclosure, including the steps of:
(1) connecting a connection terminal S2 to a 0-10 V/1-10 V dimmer, an adjustable potentiometer, or a PWM signal, and converting, by a driving chip U1, an inputted signal into a PWM signal with a duty cycle of 0% to 100%, and outputting a PWMA signal and a PWMB signal that are complementary;
(2) connecting the PWMA signal output terminal first to the optocoupler U2 for isolation, and then to the gates of a MOS transistor QS1 and a MOS transistor QS4; and connecting the PWMB signal output terminal first to the optocoupler U3 for isolation, and then to the gates of a MOS transistor QS2 and a MOS transistor QS3;
(3) controlling switch duty cycles of the MOS transistor QS1, the MOS transistor QS2, the MOS transistor QS3, and the MOS transistor QS4 to realize the current control of outer-ring low-color-temperature LEDs AW, inner-ring low-color-temperature LEDs BW, inner-ring high-color-temperature LEDs BC, and outer-ring high-color-temperature LEDs AC, thereby realizing brightness adjustment of corresponding LEDs; and
(4) consequently adjusting the light-emitting angle of the lamp under the action of a lens 1.

In summary, the lens 1 of the present disclosure includes the first lens portion 3 and the second lens portion 4 having different light-emitting angles, and the outer-ring light sources 21 corresponding to the first lens portion 3 and the inner-ring light sources 22 corresponding to the second lens portion 4 are provided. The current ratio between the outer-ring light source 21 and the inner-ring light source 22 is adjusted through the dimming control circuit to adjust the light-emitting angle. In the present disclosure, the loss of optical efficiency caused by the traditional way of adjusting the focal length of the lens is avoided, and only one layer of lens structure is provided, thereby reducing the loss of luminous flux. There is no need to disassemble the lens, which makes the operation more convenient and avoids potential water leakage risks. In the present disclosure, the color temperature adjusting DIP switch is further provided, which can not only adjust the light-emitting angle, but also adjust the color temperature, thereby increasing the diversity of the lamp. In the lens 1 of the present disclosure, the first lens portion 3 and the second lens portion 4 may be superimposed or may be separately provided, thereby increasing the diversity of the structure of the lens 1.

While the embodiments of the present disclosure have been shown and described, it will be understood by a person skilled in the art that various changes, modifications, substitutions, and alterations may be made to these embodiments without departing from the principles and spirit of the present disclosure, and the scope of the present disclosure is defined by the appended claims and their equivalents.

What is claimed is:

1. An optical structure of a lamp, the optical structure comprising a light source plate, a dimming control circuit connected to the light source plate, and a lens corresponding to the light source plate, wherein the light source plate is provided with a plurality of outer-ring light sources forming an outer ring, and a plurality of inner-ring light sources forming an inner ring are provided on an inner side of the outer-ring light sources; the lens comprises a first lens portion provided opposite to the outer-ring light sources and a second lens portion provided opposite to the inner-ring light sources, and the first lens portion has a light-emitting angle that is different from a light-emitting angle of the second lens portion;
wherein the dimming control circuit is configured to adjust a current ratio between the outer-ring light sources and the inner-ring light sources to regulate a light-emitting angle of the lamp.

2. The optical structure according to claim 1, wherein the dimming control circuit comprises a dimming drive circuit, and the dimming drive circuit comprises a driving chip U1 and a connection terminal S2; the driving chip U1 has a first pin, a second pin, a third pin, a fourth pin, a fifth pin, a sixth pin, a seventh pin, and an eighth pin, the connection terminal S2 has a first pin, a second pin, a third pin, and a fourth pin;
the third pin of the driving chip U1 is connected to an anode of a diode DS5, a terminal of a capacitor CS1, a terminal of a capacitor CE1, a cathode of a diode DS4, and the third pin of the connection terminal S2;
a cathode of the diode DS5 is connected to a +12 V power supply;
the fourth pin of the driving chip U1 is connected to the +12 V power supply and a terminal of a capacitor C3;
the eighth pin of the driving chip U1 is connected to a terminal of a capacitor CS2;
the fourth pin of the connection terminal S2 is connected to a terminal of a resistor RS1;
the second pin of the connection terminal S2 is connected to a terminal of a resistor RS2;
the first pin of the connection terminal S2 is connected to a terminal of a resistor RS3;
the fifth pin of the driving chip U1 is connected to another terminal of each of the capacitor CS1, the capacitor CE1, the capacitor CS2, the capacitor C3, the resistor RS1, the resistor RS2, and the resistor RS3 and an anode of the diode DS4;
the sixth pin of the driving chip U1 is connected to a terminal of a resistor RS6, and another terminal of the resistor RS6 is a pulse width modulation channel A (PWMA) signal output terminal; and
the seventh pin of the driving chip U1 is connected to a terminal of a resistor RS5, and another terminal of the resistor RS5 is a pulse width modulation channel B (PWMB) signal output terminal.

3. The optical structure according to claim 2, wherein the dimming control circuit further comprises an isolation circuit, and the isolation circuit comprises an optocoupler U2 and an optocoupler U3, wherein a first pin of the optocoupler U2 is connected to the PWMA signal output terminal, and a first pin of the optocoupler U3 is connected to the PWMB signal output terminal; a second pin of the optocoupler U2 and a second pin of the optocoupler U3 are connected to the fifth pin of the driving chip U1, a third pin of the optocoupler U2 and a third pin of the optocoupler U3 are connected to a power supply V−, and a fourth pin of the optocoupler U2 and a fourth pin of the optocoupler U3 are connected to a power supply V+.

4. The optical structure according to claim 3, wherein the dimming control circuit further comprises a switching circuit, and the switching circuit comprises a metal oxide semiconductor (MOS) transistor QS1 and a MOS transistor QS2,
wherein a drain of the MOS transistor QS1 is connected to cathodes of the outer-ring light sources;
a gate of the MOS transistor QS1 is connected to a Zener diode ZD4, a resistor RS7, and the fourth pin of the optocoupler U2;
a drain of the MOS transistor QS2 is connected to cathodes of the inner-ring light sources;
a gate of the MOS transistor QS2 is connected to a Zener diode ZD3, a resistor RS8, and the fourth pin of the optocoupler U3; and
a source of the MOS transistor QS1, a source of the MOS transistor QS2, and another terminal of each of the Zener diode ZD3, the resistor, the Zener diode ZD4, and the resistor RS7 are connected to the power supply V−.

5. The optical structure according to claim 4, wherein a resistor R1 and a resistor R4 are connected in series between the gate of the MOS transistor QS1 and the power supply V+, and a resistor R2 and a resistor R3 are connected in series between the gate of the MOS transistor QS2 and the power supply V+.

6. The optical structure according to according to claim 1, wherein the first lens portion and the second lens portion are superimposed.

7. The optical structure according to claim 1, wherein the second lens portion is provided on an inner-ring side of the first lens portion.

8. The optical structure according to claim 5, wherein the dimming control circuit further comprises a color temperature adjusting dual in-line package (DIP) switch S1, a MOS transistor QS3, and a MOS transistor QS4;
the outer-ring light sources comprise a plurality of outer-ring light emitting diodes (LEDs) AW with lower color temperature and a plurality of outer-ring LEDs AC with higher color temperature, and the inner-ring light sources comprise a plurality of inner-ring LEDs BW with lower color temperature and a plurality of inner-ring LEDs BC with higher color temperature;
the color temperature adjusting DIP switch S1 has a first pin, a second pin, a third pin, a fourth pin, a fifth pin, a sixth pin, a seventh pin, and an eighth pin;
the fifth pin of the color temperature adjusting DIP switch S1 is connected to the sixth pin of the color temperature adjusting DIP switch S1 to serve as an adjustment pin, and the adjustment pin is connected to the power supply V+;
the seventh pin of the color temperature adjusting DIP switch S1 is connected to the eighth pin of the color temperature adjusting DIP switch S1 to serve as a higher-color-temperature mode pin, and the higher-color-temperature mode pin is further connected to the third pin of the color temperature adjusting DIP switch S1;
the first pin of the color temperature adjusting DIP switch S1 is connected to the second pin of the color temperature adjusting DIP switch S1 to serve as a lower-color-temperature mode pin, and the lower-color-temperature mode pin is further connected to the fourth pin of the color temperature adjusting DIP switch S1;
wherein anodes of the outer-ring LEDs AW and the inner-ring LEDs BW are connected to the lower-color-temperature mode pin;
cathodes of the outer-ring LEDs AW are connected to the drain of the MOS transistor QS1, and cathodes of the inner-ring LEDs BW are connected to the drain of the MOS transistor QS2;
anodes of the outer-ring LEDs AC and the inner-ring LEDs BC are connected to the higher-color-temperature mode pin;
cathodes of the outer-ring LEDs AC are connected to a drain of the MOS transistor QS4, and cathodes of the inner-ring LEDs BC are connected to a drain of the MOS transistor QS3;
a gate of the MOS transistor QS3 is connected to a terminal of a Zener diode ZD5, a terminal of a resistor RS9, and the fourth pin of the optocoupler U3;
a gate of the MOS transistor QS4 is connected to a terminal of a Zener diode ZD6, a terminal of a resistor RS10, and the fourth pin of the optocoupler U2; and
a source of the MOS transistor QS3, a source of the MOS transistor QS4, and another terminal of each of the Zener diode ZD5, the resistor RS9, the Zener diode ZD3, and the resistor RS8 are connected to the power supply V−.

9. A method for adjusting a light-emitting angle of a lamp, comprising:
providing the optical structure of claim 1; and
adjusting the current ratio between the outer-ring light sources and the inner-ring light sources via the dimming control circuit to regulate the light-emitting angle of the lamp.

10. The method of claim 9, wherein the dimming control circuit comprises a dimming drive circuit, the dimming drive circuit comprises a driving chip U1, a connection terminal S2, and an isolation circuit, the isolation circuit comprises an optocoupler U2 and an optocoupler U3, the outer-ring light sources comprise a plurality of outer-ring light emitting diodes (LEDs) AW with lower color temperature and a plurality of outer-ring LEDs AC with higher color temperature, and the inner-ring light sources comprise a plurality of inner-ring LEDs BW with lower color temperature and a plurality of inner-ring LEDs BC with higher color temperature;
the method further comprises:
connecting the connection terminal S2 to a dimmer, an adjustable potentiometer,
or a pulse width modulation (PWM) signal source;
converting, by the driving chip U1, an inputted dimming signal into a PWM signal with a duty cycle of 0% to 100%, and outputting a pulse width modulation channel A (PWMA) signal and a pulse width modulation channel B (PWMB) signal that are complementary;
connecting a PWMA signal output terminal to gates of a metal oxide semiconductor (MOS) transistor QS1 and a MOS transistor QS4 after isolation via the optocoupler U2;
connecting a PWMB signal output terminal to gates of a MOS transistor QS2 and a MOS transistor QS3 after isolation via the optocoupler U3; and
controlling switch duty cycles of the MOS transistor QS1, the MOS transistor QS2, the MOS transistor QS3, and the MOS transistor QS4 to regulate currents of the outer-ring LEDs AW, the inner-ring LED BW, the inner-ring LED BC, and the outer-ring LEDs AC, thereby adjusting brightness of corresponding LEDs and consequently adjusting the light-emitting angle of the lamp under effect of the lens.
